(19) United States
(12) Patent Application Publication
(10) Pub. No.: US 2026/0082315 A1
(43) Pub. Date: Mar. 19, 2026

(54) INFORMATION TERMINAL, COMMUNICATION SYSTEM, DISPLAY METHOD, AND RECORDING MEDIUM

(71) Applicant: Panasonic Intellectual Property Management Co., Ltd., Osaka (JP)

(72) Inventors: Kazuma NISHIYASU, Nara (JP); Yuta TOMIO, Osaka (JP); Kosuke KAMEDA, Osaka (JP)

(21) Appl. No.: 19/313,387

(22) Filed: Aug. 28, 2025

(30) Foreign Application Priority Data
Sep. 19, 2024 (JP) 2024-162014

(51) Int. Cl. H04W 48/16; H04B 17/23; H04B 17/318

(52) U.S. Cl. CPC H04W 48/16; H04B 17/23; H04B 17/318

(57) ABSTRACT

An information terminal includes: a wireless communicator that receives a beacon signal emitted by a lighting fixture; a display; storage; and an information processor that, when the beacon signal is received, (a) generates identification information for display, (b) stores, in the storage, a correspondence relationship between the identification information for display generated and unique identification information of the lighting fixture included in the beacon signal received, and (c) displays, on the display, an icon to which is assigned the identification information for display generated, the icon indicating the lighting fixture.

### CROSS REFERENCE TO RELATED APPLICATION

This application claims the benefit of priority of Japanese Patent Application No. 2024-162014 filed on Sep. 19, 2024, the entire content of which is hereby incorporated by reference.

### TECHNICAL FIELD

The present disclosure relates to an information terminal used to make initial settings and the like in a communication system.

### BACKGROUND ART

Japanese Unexamined Patent Application Publication (Translation of PCT Application) No. 2022-508485 discloses a technique related to a method for exchanging header information for data transmission and reception.

### SUMMARY

The present disclosure provides an information terminal and the like capable of managing identification information for display assigned to an icon of a wireless communication device when the icon is displayed, and unique identification information of the wireless communication device.

An information terminal according to one aspect of the present disclosure includes: a wireless communicator that receives a beacon signal emitted by a wireless communication device; a display; storage; and an information processor that, when the beacon signal is received, (a) generates identification information for display, (b) stores, in the storage, a correspondence relationship between the identification information for display generated and unique identification information of the wireless communication device included in the beacon signal received, and (c) displays, on the display, an icon to which is assigned the identification information for display generated, the icon indicating the wireless communication device.

A communication system according to one aspect of the present disclosure includes the information terminal and the wireless communication device.

A display method according to one aspect of the present disclosure is a display method executed by an information terminal including a display and storage. The display method includes: receiving a beacon signal emitted by a wireless communication device; and when the beacon signal is received, (a) generating identification information for display, (b) displaying, on the display, an icon to which is assigned the identification information for display generated, the icon indicating the wireless communication device, and (c) storing, in the storage, a correspondence relationship between the identification information for display generated and unique identification information of the wireless communication device included in the beacon signal received.

A recording medium according to one aspect of the present disclosure is a non-transitory computer-readable recording medium having recorded thereon a program for causing the information terminal to execute the display method according to one aspect of the present disclosure.

An information terminal of the present disclosure is capable of managing identification information for display assigned to an icon of a wireless communication device when the icon is displayed, and unique identification information of the wireless communication device.

### BRIEF DESCRIPTION OF THE DRAWINGS

The figures depict one or more implementations in accordance with the present teaching, by way of examples only, not by way of limitations. In the figures, like reference numerals refer to the same or similar elements.

FIG. 1 is a block diagram illustrating the configuration of a lighting system according to an embodiment.

FIG. 2 is a diagram conceptually illustrating a mesh network.

FIG. 3 is a flowchart illustrating an overview of initial setting operations.

FIG. 4A is a first sequence chart illustrating initial setting operations.

FIG. 4B is a second sequence chart illustrating initial setting operations.

FIG. 5 is a diagram illustrating an example of an initial settings screen.

FIG. 6 is a flowchart illustrating an example of lighting fixture detection operations.

FIG. 7 is a diagram illustrating an example of identification information management information.

FIG. 8 is a diagram illustrating an example of an initial settings screen after a placement position has been specified.

### DETAILED DESCRIPTION

An embodiment will be described in detail hereinafter with reference to the drawings. Note that the following embodiment describes comprehensive or specific examples of the disclosure. The numerical values, shapes, materials, constituent elements, arrangements and connection states of constituent elements, steps, orders of steps, and the like in the following embodiment are merely examples, and are not intended to limit the present disclosure. Additionally, of the constituent elements in the following embodiment, constituent elements not denoted in the independent claims will be described as optional constituent elements.

Note also that the drawings are schematic diagrams, and are not necessarily exact illustrations. Configurations that are substantially the same are given the same reference signs in the drawings, and redundant descriptions may be omitted or simplified.

### Embodiment

### Configuration

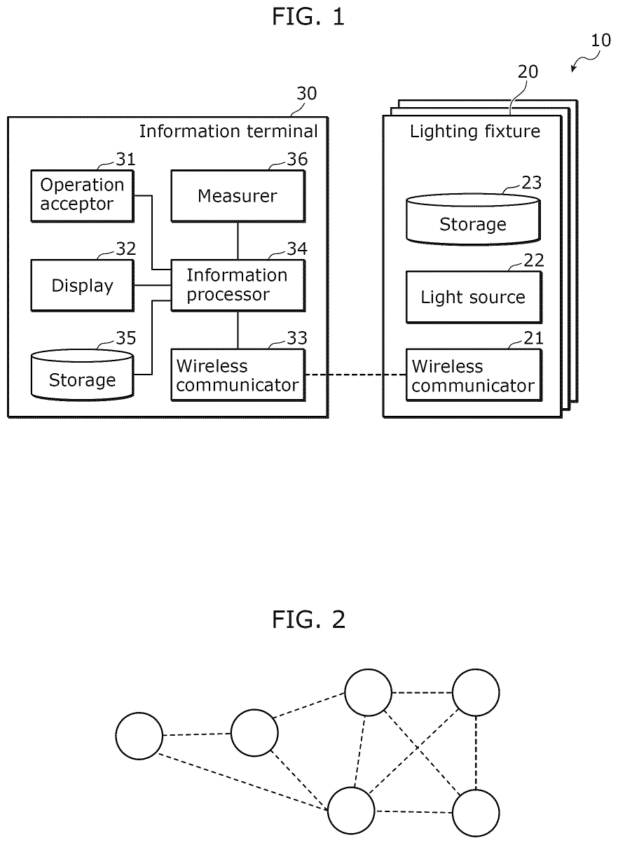

The configuration of a lighting system according to an embodiment will be described first. FIG. 1 is a block diagram illustrating the configuration of the lighting system according to an embodiment. As illustrated in FIG. 1, lighting system 10 includes a plurality of lighting fixtures 20 and information terminal 30.

In lighting system 10, each of the plurality of lighting fixtures 20 has wireless communication functionality, and the plurality of lighting fixtures 20 form a wireless mesh network (also called simply a “mesh network” hereinafter). The wireless mesh network is an example of a wireless communication network.

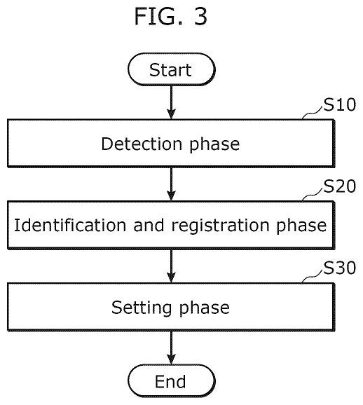

FIG. 2 is a diagram conceptually illustrating the mesh network. Each circle in FIG. 2 corresponds to one lighting fixture 20 (i.e., a communication node). In a mesh network, when information is transmitted from one communication node (also called a “first communication node”) to another communication node (also called a “second communication node”), the information is transmitted through routing, for example, but may be transmitted using other methods such as flooding.

The information transmitted over the mesh network is control information for controlling lighting fixtures 20 to turn on, turn off, or dim, for example. If an environment sensor is included in the mesh network (described later), a measured value from the environment sensor (sensing information) may be transmitted.

Lighting fixture 20 will be described first. Lighting fixture 20 is a base light which is installed in a ceiling of an interior space and illuminates the interior space. Each of the plurality of lighting fixtures 20 has wireless communication functionality as described above, and the plurality of lighting fixtures 20 form a mesh network. Note that the form of lighting fixture 20 is not particularly limited, and may be a ceiling light, a downlight, a spotlight, or the like. Lighting fixture 20 specifically includes wireless communicator 21, light source 22, and storage 23.

Wireless communicator 21 is wireless communication circuitry for lighting fixture 20 to communicate wirelessly (and more specifically, over radio waves) with other lighting fixtures 20 and information terminal 30. After lighting fixture 20 joins the mesh network, wireless communicator 21 communicates over the mesh network. Before lighting fixture 20 joins the mesh network, wireless communicator 21 periodically transmits a beacon signal (sometimes called an “advertising signal” or the like) and communicates wirelessly with information terminal 30 that receives the beacon signal. Specifically, wireless communicator 21 communicates wirelessly according to a communication standard such as Bluetooth (registered trademark) Low Energy (BLE) or Bluetooth (registered trademark) Mesh.

Light source 22 emits white light into the interior space in order for lighting fixture 20 to illuminate the interior space. Light source 22 is implemented as a Light Emitting Diode (LED) device, for example, but may be implemented as another light-emitting element such as a semiconductor laser, an organic electroluminescence (EL) device, an inorganic EL device, or the like.

Storage 23 is a storage device that stores various types of information necessary for lighting fixture 20 to operate, such as unique identification information of lighting fixture 20 and setting information (described later). Storage 23 is implemented as a semiconductor memory or the like, for example.

The configuration of information terminal 30 will be described next. Information terminal 30 is an information terminal used by a user to make settings (initial settings and setting changes) related to the mesh network and to control the plurality of lighting fixtures 20. Information terminal 30 is a mobile terminal such as a smartphone, a tablet terminal, or a Personal Digital Assistant (PDA), for example. Information terminal 30 may also be a dedicated remote controller used in lighting system 10. Information terminal 30 specifically includes operation acceptor 31, display 32, wireless communicator 33, information processor 34, storage 35, and measurer 36.

Operation acceptor 31 accepts user operations. Specifically, operation acceptor 31 is implemented as a touch panel or the like.

Display 32 displays various images. Display 32 is implemented as a display panel such as a liquid crystal panel, an organic EL panel, or the like, for example.

Wireless communicator 33 is wireless communication circuitry for information terminal 30 to communicate wirelessly (and more specifically, over radio waves) with each of the plurality of lighting fixtures 20. Specifically, wireless communicator 33 communicates wirelessly according to a communication standard such as BLE.

Information processor 34 processes information in response to a user operation accepted by operation acceptor 31. Information processor 34 is implemented by a microcomputer, for example, but may be implemented by a processor or dedicated circuitry. The functions of information processor 34 are implemented by the hardware constituting information processor 34, such as a microcomputer or a processor, executing a computer program (software) stored in storage 35.

Storage 35 is a storage device that stores information necessary for information processing, such as a computer program executed by information processor 34. Storage 35 is implemented as semiconductor memory or the like, for example.

Measurer 36 is measurement circuitry that measures the received signal strength (Received Signal Strength Indicator; RSSI) of the beacon signal emitted by lighting fixture 20, received by wireless communicator 33. Measurer 36 may be included in the wireless communication circuitry of wireless communicator 33.

### Initial Setting Operations

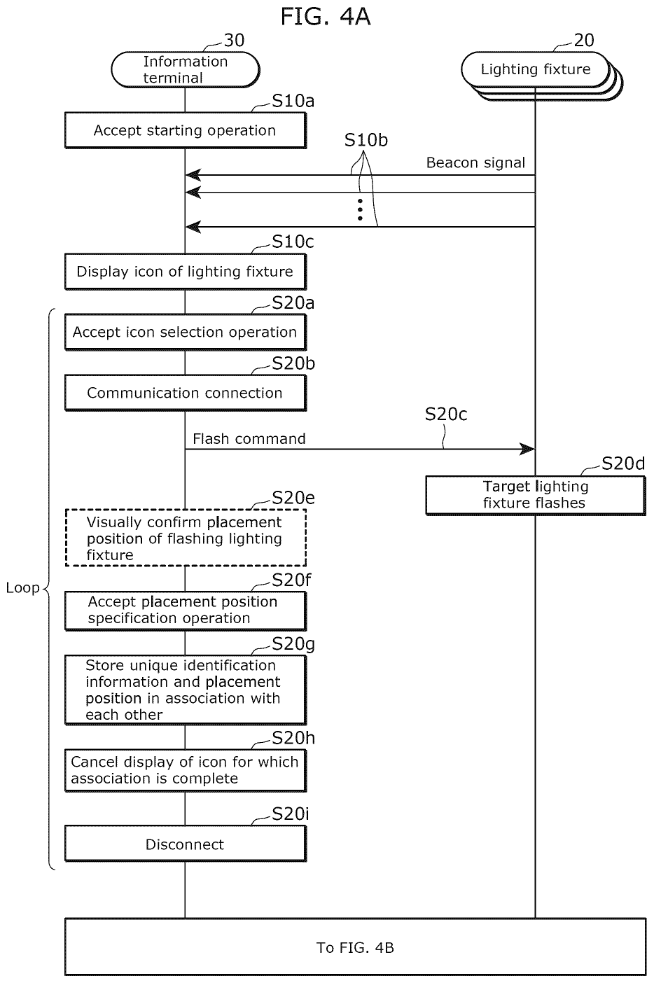

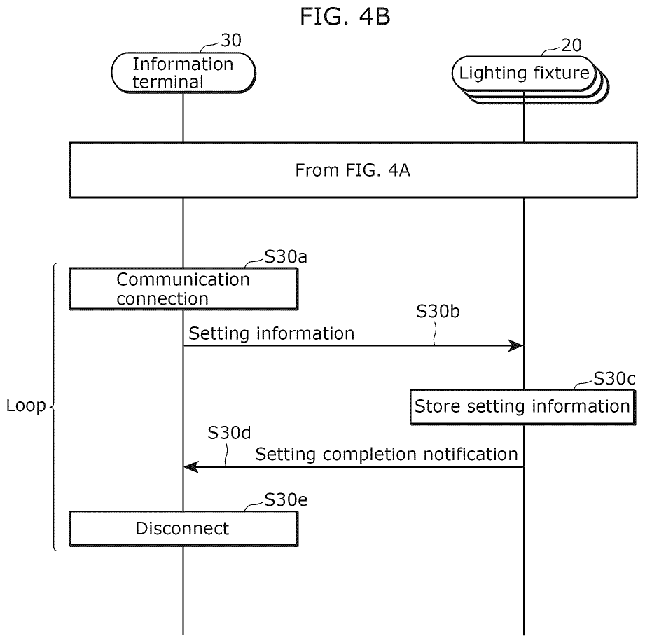

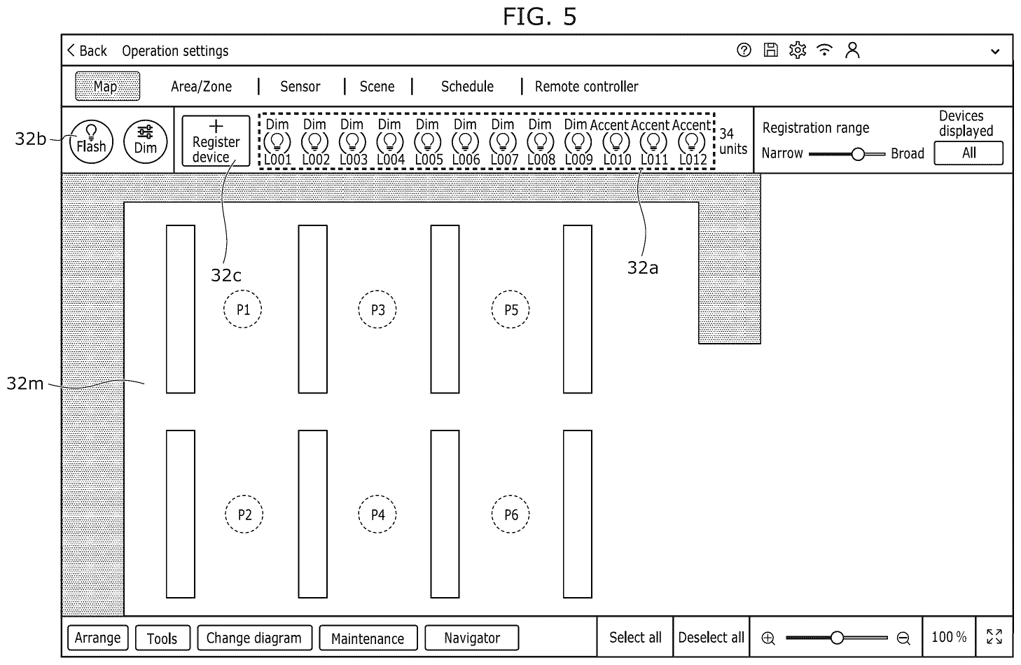

Information terminal 30 can construct a mesh network by performing initial setting operations. Initial setting operations will be described here. FIG. 3 is a flowchart illustrating an overview of the initial setting operations. As illustrated in FIG. 3, the initial setting operations include detection phase S10, identification and registration phase S20, and setting phase S30, in that order. Specific processing performed in each phase will be described hereinafter with reference to sequence charts. FIGS. 4A and 4B are sequence charts illustrating the initial setting operations. FIG. 5 is a diagram illustrating an example of an initial settings screen. The initial setting operations illustrated in FIGS. 4A and 4B are performed, for example, after the plurality of lighting fixtures 20 are installed in a ceiling by an installing party.

Processing performed in detection phase S10 will be described first. Operation acceptor 31 of information terminal 30 accepts, from the user, a starting operation for detecting lighting fixtures 20 (scanning) (S10a). The starting operation is an operation of tapping detection icon 32c in the initial settings screen illustrated in FIG. 5.

Here, before joining the mesh network, each of the plurality of lighting fixtures 20 periodically sends a beacon signal (sometimes called an “advertising signal” or the like) (S10b). In response to the starting operation of step S10a being accepted, wireless communicator 33 of information terminal 30 receives the beacon signal. The beacon signal emitted by each of the plurality of lighting fixtures 20 includes the unique identification information of the corresponding lighting fixture 20. The unique identification information may be a MAC (Media Access Control) address, for example, but is not limited to a MAC address as long as lighting fixture 20 can be uniquely identified.

Information processor 34 displays, on display 32, an icon of lighting fixture 20 that sent the received beacon signal (S10c). As illustrated in FIG. 5, in the initial settings screen, a plurality of icons 32a corresponding to the plurality of lighting fixtures 20 from which the beacon signals originated are displayed side by side in a row.

Map image 32m is also displayed in the initial settings screen illustrated in FIG. 5. Map image 32m is a view of the area where the plurality of lighting fixtures 20 are installed from above, and in the example in FIG. 5, placement positions P1 to P6 of lighting fixtures 20 are indicated by circles. In other words, map image 32m is an image indicating the placement positions of the plurality of lighting fixtures 20. Map image 32m is stored in storage 35 in advance.

At the time of step S10c, the manner in which the plurality of lighting fixtures 20 are arranged is known, but which lighting fixture 20 is located at which position is unknown. In other words, at the time of step S10c, the placement positions of lighting fixtures 20 are not yet associated with unique identification information of lighting fixtures 20.

The processing of steps S10a to S10c described above is the processing performed in detection phase S10. Processing performed in identification and registration phase S20 will be described next.

Operation acceptor 31 accepts, from the installing party, a selection operation of the plurality of icons 32a (S20a). The selection operation is, for example, an operation of tapping one of the plurality of icons 32a. Based on the selection operation accepted by operation acceptor 31, information processor 34 establishes a communication connection between lighting fixture 20 corresponding to the selected icon 32a (also called “target lighting fixture 20” hereinafter) and wireless communicator 33 (S20b), and starts individual communication (one-to-one communication) with target lighting fixture 20. Information processor 34 causes wireless communicator 33 to transmit a flash command (S20c). The flash command is transmitted in response to a tapping operation made on flash icon 32b made after the selection operation, for example.

The flash command is control information (a control command) for selectively causing target lighting fixture 20 to flash. Target lighting fixture 20 flashes upon receiving the flash command (S20d). This enables the user to identify target lighting fixture 20.

The user visually confirms the actual placement position of target lighting fixture 20 that is flashing (S20e), and specifies the placement position of target lighting fixture 20 that is flashing (e.g., one of placement positions P1 to P6) on map image 32m. Operation acceptor 31 accepts, from the user, an operation for specifying the placement position of lighting fixture 20 in map image 32m (S20f). Then, information processor 34 stores the unique identification information indicated by icon 32a selected in step S20a and the placement position (coordinates) specified in step S20f in association with each other in storage 35 (S20g). Information processor 34 also stops displaying icon 32a for which the association is complete (S20h). In other words, the number of the plurality of icons 32a displayed in step S10c is reduced by one. Information processor 34 then terminates the communication connection with target lighting fixture 20 (S20i).

The processing of steps S20a to S20i is repeated until all icons 32a (the unique identification information) displayed in step S10c are associated with placement positions. Correspondence information indicating the correspondence relationship between the unique identification information of the plurality of lighting fixtures 20 and the placement positions thereof is stored in storage 35 as a result. In other words, the plurality of lighting fixtures 20 are registered with information terminal 30.

The processing of steps S20a to S20i described above is the processing performed in identification and registration phase S20. Processing performed in setting phase S30 will be described next. The processing performed in setting phase S30 is processing which is also called “provisioning” or the like.

Based on an operation accepted by operation acceptor 31, such as specifying one of lighting fixtures 20, information processor 34 establishes a communication connection between the specified lighting fixture 20 and wireless communicator 33 (S30a), and starts individual communication with lighting fixture 20. Information processor 34 causes wireless communicator 33 to transmit setting information to lighting fixture 20 (S30b). Lighting fixture 20 receives the setting information and stores the setting information in storage 23 provided in lighting fixture 20 (S30c).

The setting information is information for lighting fixture 20 to join the mesh network. The setting information includes a network ID of the mesh network which lighting fixture 20 is on and address information (a unicast address) of lighting fixture 20 used for communication within the mesh network. If necessary, the setting information also includes a security passcode (authentication information) used for communication within the mesh network, channel information indicating a frequency channel used for wireless communication in the mesh network, and unique identification information of information terminal 30 that performed the initial setting operations. Lighting fixture 20 for which the setting information is stored in storage 23 can join the mesh network.

Once the setting information is stored, lighting fixture 20 transmits a setting completion notification to information terminal 30 (S30d). When the setting completion notification is received by wireless communicator 33, information processor 34 of information terminal 30 terminates the communication connection with lighting fixture 20 communicatively connected in step S30a (S30e).

The processing of steps S30a to S30e is repeated until all lighting fixtures 20 join the mesh network. If necessary, lighting fixture 20 which has joined the mesh network stops periodically transmitting the beacon signal sent before joining the mesh network.

The processing of steps S30a to S30e described above is processing performed in setting phase S30 (also called “setting processing”).

Note that the processing of step S20i and the processing of step S30a can be omitted. In other words, the processing of steps S30b to S30e may be performed without terminating the communication connection in step S20i.

As described above, information terminal 30 can cause the plurality of lighting fixtures 20 to join the mesh network by performing the initial setting operations. In other words, information terminal 30 can construct a mesh network.

### Management of Identification Information for Display

The word “dim” above icon 32a displayed on the initial settings screen in FIG. 5 means the type (function) of lighting fixture 20, and specifically means that lighting fixture 20 is a lighting fixture that supports dimming. Text such as “L001” below icon 32a is identification information for display, for distinguishing icon 32a.

Here, it is conceivable to extract a part of the character string of the unique identification information (MAC address) included in the beacon signal and use that extracted information as the identification information for display. However, in that case, the identification information for display of icon 32a, indicating certain lighting fixture 20, may overlap with the identification information for display of another lighting fixture 20, and it may be difficult for the installing party to distinguish icon 32a.

Accordingly, information processor 34 of information terminal 30 generates the identification information for display, which is separate from the unique identification information, and displays that information with icon 32a. However, when lighting fixture 20 detected through the processing of detection phase S10 is assigned the identification information for display once and that lighting fixture 20 is detected again as a result of, for example, redoing the processing of detection phase S10, new identification information for display is assigned. In other words, since the identification information for display assigned to icon 32a indicating the same lighting fixture 20 changes each time detection phase S10 is performed, it is difficult for the installing party to identify lighting fixture 20.

Accordingly, when the identification information for display is generated for lighting fixture 20 detected for the first time, information processor 34 stores the correspondence relationship between the generated identification information for display and the unique identification information of that lighting fixture 20 in storage 35. Then, if the identification information for display has already been generated for a detected lighting fixture 20, icon 32a of that lighting fixture 20 is assigned the identification information for display that has already been generated. As a result, the same identification information for display is assigned to the same lighting fixture 20, which enables the installing party to easily identify lighting fixture 20.

### Lighting Fixture Detection Operations

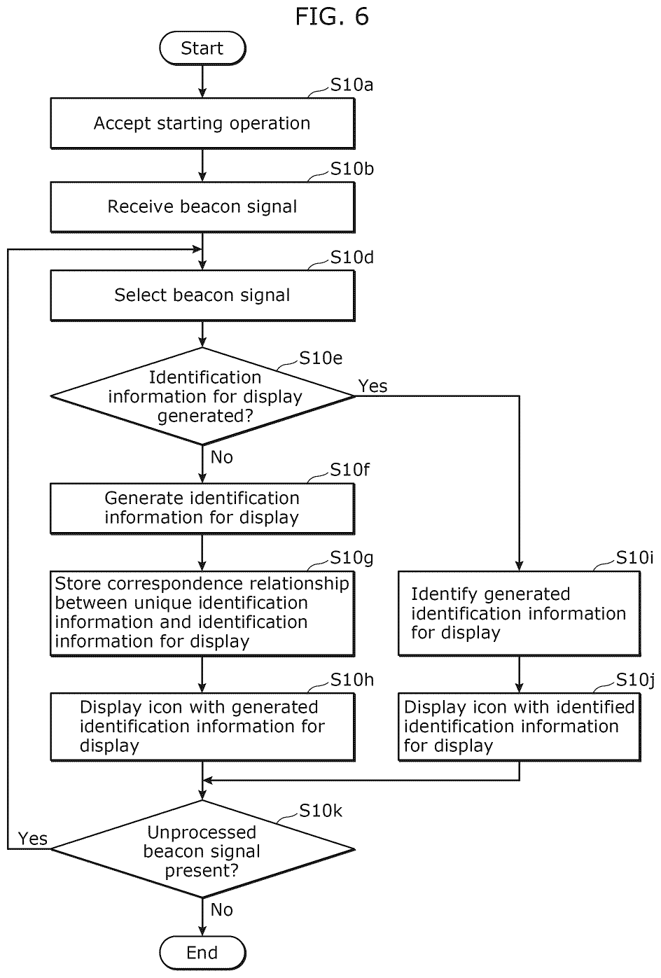

Operations for detecting lighting fixture 20 (operations performed in the detection phase) when the correspondence relationship between the identification information for display and the unique identification information is stored as mentioned above will be described hereinafter. FIG. 6 is a flowchart illustrating an example of operations for detecting lighting fixture 20.

Operation acceptor 31 of information terminal 30 accepts a starting operation, instructing the initial setting operations to be started, from the user (S10a). Wireless communicator 33 of information terminal 30 receives at least one beacon signal (S10b).

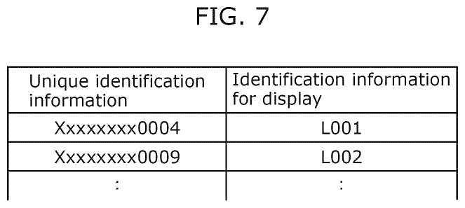

From the at least one beacon signal received, information processor 34 selects one beacon signal for which the processing from step S10d has not yet been performed (S10d). Information processor 34 determines whether the identification information for display corresponding to the unique identification information included in the selected beacon signal has already been generated by referring to identification information management information stored in storage 35 (S10e). FIG. 7 is a diagram illustrating an example of the identification information management information. As illustrated in FIG. 7, the identification information management information is information indicating the correspondence relationship between the unique identification information and the identification information for display.

Information processor 34 determines that the identification information for display has not yet been generated (No in S10e), and generates the identification information for display (S10f). The identification information for display is expressed as letters and numbers following the letters, for example, where the letters indicate a device type (L, in the case of lighting fixture 20). Note that such identification information for display is merely example, and the specific form of the identification information for display is not particularly limited.

Next, information processor 34 stores the correspondence relationship between the unique identification information included in the received beacon signal and the identification information for display generated in step S10f in storage 35 (S10g). In step S10g, information processor 34 updates the identification information management information by adding the correspondence relationship between the unique identification information included in the received beacon signal and the generated identification information for display to the identification information management information stored in storage 35 (FIG. 7).

Then, information processor 34 displays, on display 32, icon 32a, which is icon 32a of lighting fixture 20 that emitted the received beacon signal and to which the identification information for display generated in step S10f has been assigned (S10h).

On the other hand, if the identification information for display is determined to have already been generated (Yes in S10e), information processor 34 specifies the identification information for display associated with the unique identification information in the identification information management information (S10i). Then, information processor 34 displays, on display 32, icon 32a, which is icon 32a of lighting fixture 20 that emitted the received beacon signal and to which the identification information for display specified in step S10i has been assigned (S10j).

After the processing of step S10h or step S10j, information processor 34 determines whether the at least one beacon signal received in step S10b include an unprocessed beacon signal (whether all beacon signals have been processed) (S10k). If information processor 34 determines that an unprocessed beacon signal is present (Yes in S10k), information processor 34 selects the unprocessed beacon signal (S10d), and the processing from step S10d is performed. If all beacon signals have been processed and no unprocessed beacon signals are determined to be present (No in S10k), the operation ends.

In this manner, by using the identification information management information, information terminal 30 can assign the same identification information for display to icon 32a indicating the same lighting fixture 20, even if the same lighting fixture 20 is detected a plurality of times. As a result, the installing party can easily identify lighting fixture 20.

Note that if wireless communicator 33 receives a plurality of beacon signals corresponding to the plurality of lighting fixtures 20 in step S10b, the processing after step S10d is repeated a plurality of times. In this case, for example, in step S10d, the beacon signal, among the unprocessed beacon signals, for which with the reception processing has been completed the soonest is selected, and the number of the identification information for display generated in step S10f is incremented (or decremented) each time a new beacon signal is generated. As a result, the plurality of icons 32a displayed in the initial settings screen are assigned a number indicating the order in which the beacon signals were received.

Additionally, after step S10b, measurer 36 may measure the received signal strength of each of the at least one beacon signal received in step S10b. In this case, for example, in step S10d, the beacon signal, among the unprocessed beacon signals, that has the highest received signal strength is selected, and the number of the identification information for display generated in step S10f is incremented (or decremented) with each new generation. As a result, the plurality of icons 32a displayed in the initial settings screen are assigned a number indicating the order in the received signal strengths.

As described with reference to step S20e above, the user visually verifies the actual placement position of lighting fixture 20 against the position on map image 32m. However, if, in step S20a, icon 32a of lighting fixture 20 far away from the user is selected, lighting fixture 20 that is far away from the user will flash. The user will therefore not be able to ascertain the exact placement position of lighting fixture 20 that is flashing, and will need to move to ascertain the precise placement position. In other words, there is a problem that the work may be prolonged.

However, the received signal strength has a meaning close to the distance between information terminal 30 and lighting fixture 20 from which the beacon signal was emitted. As such, this problem is addressed by assigning a number indicating the order in received signal strengths to icon 32a, which enables the installing party to preferentially select lighting fixture 20 thought to be located nearby and improve the efficiency of their work.

### Replacing Identification Information for Display With Identification Information Corresponding to Installation Location

After the operations for detecting lighting fixture 20 described above, the processing of identification and registration phase S20 is performed. After specifying the placement position of lighting fixture 20 on map image 32m in step S20f, information processor 34 of information terminal 30 may replace the identification information for display with the identification information corresponding to the specified placement position, and then display, on display 32, icon 32a to which the identification information corresponding to the placement position has been assigned.

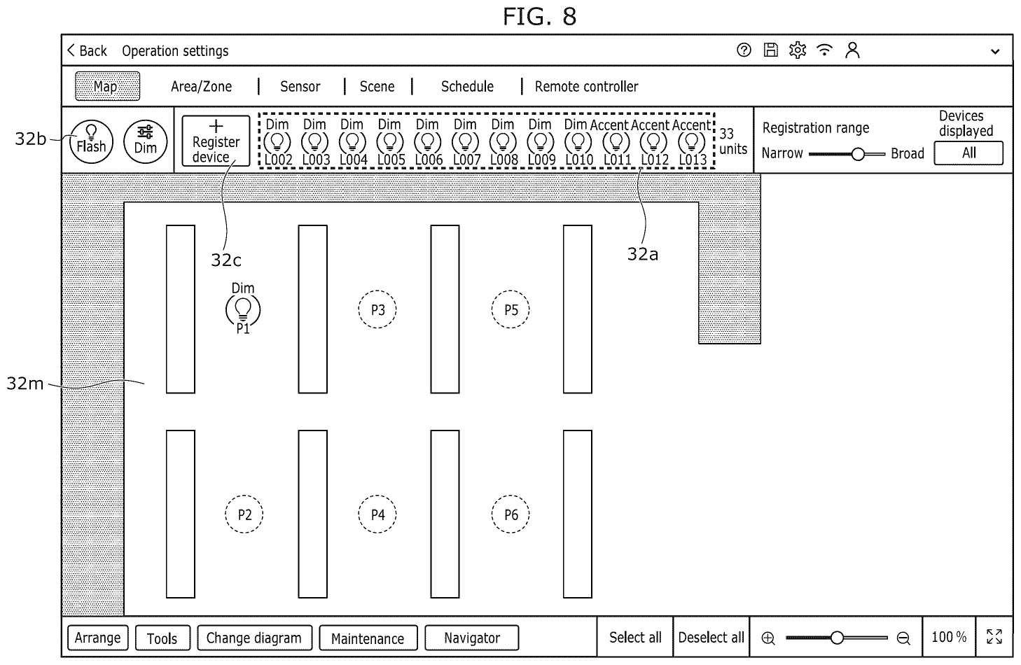

For example, assume that the operation for specifying the placement position accepted in step S20f is an operation for dragging and dropping one of icons 32a displayed in the horizontal row at the top in FIG. 5 onto one of P1 to P6 (the placement position candidates) in map image 32m. In this case, when icon 32a to which identification information for display “L001” has been assigned is dragged and dropped onto placement position P1, information processor 34 replaces “L001” of icon 32a to which identification information for display “L001” has been assigned with “P1” and displays the resulting icon 32a at placement position P1. FIG. 8 is a diagram illustrating an example of the initial settings screen after the placement position has been specified in this manner.

In this manner, information terminal 30 displays the identification information for display by replacing the identification information corresponding to the specified placement position. The installing party can easily ascertain the placement position of lighting fixture 20 from the identification information assigned to icon 32a.

### Notifying Lighting Fixtures of Identification Information for Display

At any time after the correspondence relationship between the unique identification information and the identification information for display is stored in storage 35 during the operations for detecting lighting fixture 20 described above, information processor 34 may notify lighting fixture 20 of the identification information for display assigned to that lighting fixture 20 by communicating with that lighting fixture 20 using wireless communicator 33. Lighting fixture 20 is notified of the identification information for display by being included in the flash command in step S20c of identification and registration phase S20, for example.

As a result, lighting fixture 20 that has received the notification can store the identification information for display in storage 23 and issue a beacon signal including the identification information for display instead of or in addition to the unique identification information. In addition, lighting fixture 20 that has received the notification can return the identification information for display in response to an inquiry from information terminal 30. In other words, information terminal 30 is capable of utilizing the identification information for display in other information processing.

### Variations

In the foregoing embodiment, in the initial settings screen (FIG. 5), the plurality of icons 32a corresponding to the plurality of lighting fixtures 20 from which the beacon signals were emitted are displayed side by side in a row from left to right in order from the fixture for which the beacon signal reception processing was completed first. However, the plurality of icons 32a may be displayed side by side in a row from left to right in the order from the fixture for which the received signal strength is highest.

Through this, the icons of lighting fixtures 20 which emitted the beacon signals are displayed from left to right in order from the fixture for which the received signal strength is highest, which makes it easy to register the placement position by causing lighting fixtures 20 to flash in order from lighting fixture 20 thought to be to be located near information terminal 30.

In the foregoing embodiment, in the initial settings screen (FIG. 5), the plurality of icons 32a corresponding to all lighting fixtures 20 that successfully received the beacon signals were displayed. However, the plurality of icons 32a displayed in the initial settings screen may be narrowed down. For example, only a predetermined number of icons 32a may be displayed in order from those having the highest corrected received signal strength (i.e., a predetermined number of icons 32a having the highest received signal strengths). The predetermined number may be a fixed number, or may be settable through operations made in information terminal 30 by the installing party.

Additionally, if, after the plurality of icons 32a are displayed in response to a first tapping operation on detection icon 32c (also called a “first scan” hereinafter), a second tapping operation is performed on detection icon 32c (also called a “second scan” hereinafter), a plurality of first icons corresponding to the plurality of lighting fixtures 20 detected the first time are hidden (cleared), and a plurality of second icons corresponding to the plurality of lighting fixtures 20 detected the second time are displayed.

However, the plurality of first icons may remain displayed, and the plurality of second icons may be displayed to the right thereof, or the plurality of second icons may be displayed, and the plurality of first icons may be displayed to the right thereof. When both the plurality of first icons and the plurality of second icons are displayed, the plurality of first icons may be displayed in a display format that is different from the plurality of second icons. In this case, the “different display format” means that at least one of the colors, patterns, sizes, shapes, or the like of the icons are different. The different display formats may be implemented by superimposing marks or text onto the icons.

In the foregoing embodiments, each of the plurality of wireless communication devices constituting the mesh network was lighting fixture 20, but the wireless communication devices need not be lighting fixtures 20. The plurality of wireless communication devices may include lighting fixtures 20 and other devices, or may include only other wireless communication devices without including lighting fixtures 20. Information terminal 30 may also be included in the mesh network.

A lighting remote controller, a Pulse Width Modulation (PWM) dimmer, a scheduler, an alternating current (AC) relay, and the like operated by a user to control lighting fixtures 20 can be given as examples of the other wireless communication devices described above.

The PWM dimmer is a device capable of dimming lighting fixture 20 attached to the PWM dimmer. The scheduler is a device that turns on, turns off, or dims lighting fixture 20 according to a predetermined schedule.

The AC relay includes two types, namely a first AC relay and a second AC relay. The first AC relay is a device that is attached to a wiring duct, and can turn on and off one device attached to the wiring duct by turning on and off AC power to that one device. The second AC relay is a device that is attached to the root of a wiring duct, and can turn on and off all devices attached to the wiring duct by turning on and off the supply of AC power to the wiring duct. The AC relay may also be a wireless control switch or the like that does not utilize a wiring duct.

The other wireless communication device may also be a device that is not directly related to lighting, such as an air conditioner, a ventilation device, a camera, a speaker, a human sensor, or an environment sensor. The environment sensor includes a temperature sensor, a humidity sensor, a carbon dioxide concentration sensor, a Particle Matter (PM) sensor, and the like.

In the foregoing embodiment, light source 22 provided in lighting fixture 20 is used as a state presenter for the installing party to visually confirm the placement position of lighting fixture 20. However, since the wireless communication devices constituting the mesh network are not limited to lighting fixtures 20, various forms are conceivable for the state presenter provided in the wireless communication device.

For example, the wireless communication device may include a light source (such as an LED indicator, if the device is not lighting fixture 20) as the state presenter. The wireless communication device may include a speaker as the state presenter, and present the state by emitting sound. The wireless communication device may use a dedicated function of the device (e.g., a blower function, if the device is an air conditioner) as the state presenter. The wireless communication device may transition to a different state than the other wireless communication devices based on a control command (control information) transmitted from information terminal 30.

### Effects, etc.

Examples of inventions achieved from the content disclosed in the present specification will be given hereinafter, and effects and the like provided by the inventions will be described as well.

Invention 1 is information terminal 30 including: wireless communicator 33 that receives a beacon signal emitted by a wireless communication device; display 32; storage 35; and information processor 34 that, when the beacon signal is received, (a) generates identification information for display, (b) stores, in storage 35, a correspondence relationship between the identification information for display generated and unique identification information of the wireless communication device included in the beacon signal received, and (c) displays, on display 32, icon 32a to which is assigned the identification information for display generated, icon 32a indicating the wireless communication device.

This information terminal 30 can manage the identification information for display assigned to icon 32a and the unique identification information of the wireless communication device.

Invention 2 is information terminal 30 of Invention 1, wherein after (b) is executed, wireless communicator 33 receives an other beacon signal emitted by the wireless communication device, and when the other beacon signal is received, information processor 34 (d) determines, by referring to storage 35, that the identification information for display corresponding to the unique identification information included in the other beacon signal has already been generated, and (e) displays, on display 32, icon 32a to which is assigned the identification information for display, icon 32a indicating the wireless communication device.

If a beacon signal is received from lighting fixture 20 for which identification information for display has already been generated in the past, this information terminal 30 can use the identification information management information to assign the identification information for display already generated. As a result, the installing party can easily identify lighting fixture 20.

Invention 3 is information terminal 30 of Invention 1 or 2, wherein when the beacon signal is received from each of a plurality of wireless communication devices, each being the wireless communication device, information processor 34 assigns a number indicating an order of reception of the beacon signal to each of a plurality of icons 32a, each being icon 32a, as the identification information for display, and displays the plurality of icons 32a on display 32.

This information terminal 30 can assign a number indicating the order in which the beacon signals were received as the identification information for display.

Invention 4 is information terminal 30 of Invention 1 or 2, further including measurer 36 that measures a received signal strength of the beacon signal received, wherein when the beacon signal is received from each of a plurality of wireless communication devices, each being the wireless communication device, information processor 34 assigns a number indicating an order of a magnitude of the received signal strength to a plurality of icons 32a, each being icon 32a, as the identification information for display, and displays the plurality of icons 32a on display 32.

This information terminal 30 can assign a number indicating the order of the received signal strengths as the identification information for display.

Invention 5 is information terminal 30 of any one of Inventions 1 to 4, further including operation acceptor 31 that accepts, from a user, an operation for specifying a placement position of the wireless communication device, wherein information processor 34 displays icon 32a on display 32 having replaced the identification information for display with identification information corresponding to the placement position specified. The installing party in the foregoing embodiment is an example of the user.

According to this information terminal 30, the user can easily ascertain the placement position of the wireless communication device from the identification information assigned to icon 32a.

Invention 6 is information terminal 30 according to any one of Inventions 1 to 5, wherein information processor 34 makes a notification of the identification information for display to the wireless communication device by communicating with the wireless communication device using wireless communicator 33, and the wireless communication device emits the beacon signal including the identification information for display after receiving the notification.

This information terminal 30 is capable of utilizing the identification information for display in other information processing.

Invention 7 is information terminal 30 according to any one of Inventions 1 to 5, wherein information processor 34 makes a notification of the identification information for display to the wireless communication device by communicating with the wireless communication device using wireless communicator 33, and the wireless communication device responds to an inquiry from information terminal 30 with the identification information for display after receiving the notification.

This information terminal 30 is capable of utilizing the identification information for display in other information processing.

Invention 8 is information terminal 30 of any one of Inventions 1 to 7, wherein the wireless communication device is lighting fixture 20 including wireless communication functionality.

This information terminal 30 can manage the identification information for display assigned to icon 32a and the unique identification information of lighting fixture 20.

Invention 9 is a communication system including information terminal 30 of any one of Inventions 1 to 8 and a wireless communication device. Lighting system 10 in the foregoing embodiment is an example of a communication system.

This communication system can manage the identification information for display assigned to icon 32a and the unique identification information of the wireless communication device.

Invention 10 is a display method executed by information terminal 30 including display 32 and storage 35, the display method including: receiving a beacon signal emitted by a wireless communication device; and when the beacon signal is received, (a) generating identification information for display, (b) displaying, on display 32, icon 32a to which is assigned the identification information for display generated, icon 32a indicating the wireless communication device, and (c) storing, in storage 35, a correspondence relationship between the identification information for display generated and unique identification information of the wireless communication device included in the beacon signal received.

This display method can manage the identification information for display assigned to icon 32a and the unique identification information of the wireless communication device.

Invention 11 is a non-transitory computer-readable recording medium having recorded thereon a program for causing information terminal 30 to execute the display method of Invention 10.

According to this program, information terminal 30 can manage the identification information for display assigned to icon 32a and the unique identification information of the wireless communication device.

### Other Embodiments

Although an embodiment has been described thus far, the present disclosure is not limited to the foregoing embodiment.

For example, processing executed by a specific processing unit in the foregoing embodiment may be executed by a different processing unit. Additionally, the order of multiple processes may be changed, and multiple processes may be executed in parallel.

Additionally, in the foregoing embodiment, the constituent elements may be implemented by executing software programs corresponding to those constituent elements. Each constituent element may be realized by a program executing unit such as a CPU or a processor reading out and executing a software program recorded into a recording medium such as a hard disk or semiconductor memory.

Each constituent element may be implemented by hardware. For example, constituent elements such as controllers may be circuitry (or integrated circuitry). This circuitry may constitute a single overall circuit, or may be separate circuits. The circuitry may be generic circuitry, or may be dedicated circuitry.

The general or specific aspects of the present disclosure may be implemented by a system, a device, a method, an integrated circuit, a computer program, or a computer-readable recording medium such as a CD-ROM. These forms may also be implemented by any desired combination of systems, devices, methods, integrated circuits, computer programs, and recording media.

For example, the present disclosure may be implemented as a communication system or an information terminal according to the foregoing embodiment, or as a display method executed by an information terminal. The present disclosure may be implemented as a program for causing an information terminal (a computer) to execute such a display method, or as a non-transitory computer-readable recording medium having such a program recorded thereon. The program is, in other words, a computer program product. Such a program includes an application program for causing a computer, such as a general-purpose information terminal or the like, to function as an information terminal according to the foregoing embodiments.

Note that embodiments resulting from variations of the above embodiments arrived at by those skilled in the art, as well as embodiments resulting from optional combinations of elements and functions in the above embodiments are included within the present disclosure as long as the embodiments do not depart from the scope of the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. An information terminal comprising:
a wireless communicator that receives a beacon signal emitted by a wireless communication device;
a display;
storage; and
an information processor that, when the beacon signal is received, (a) generates identification information for display, (b) stores, in the storage, a correspondence relationship between the identification information for display generated and unique identification information of the wireless communication device included in the beacon signal received, and (c) displays, on the display, an icon to which is assigned the identification information for display generated, the icon indicating the wireless communication device.

2. The information terminal according to claim 1,
wherein after (b) is executed, the wireless communicator receives an other beacon signal emitted by the wireless communication device, and
when the other beacon signal is received, the information processor (d) determines, by referring to the storage, that the identification information for display corresponding to the unique identification information included in the other beacon signal has already been generated, and (e) displays, on the display, an icon to which is assigned the identification information for display, the icon indicating the wireless communication device.

3. The information terminal according to claim 1,
wherein when the beacon signal is received from each of a plurality of wireless communication devices, each being the wireless communication device, the information processor assigns a number indicating an order of reception of the beacon signal to each of a plurality of icons, each being the icon, as the identification information for display, and displays the plurality of icons on the display.

4. The information terminal according to claim 1, further comprising:
a measurer that measures a received signal strength of the beacon signal received,
wherein when the beacon signal is received from each of a plurality of wireless communication devices, each being the wireless communication device, the information processor assigns a number indicating an order of a magnitude of the received signal strength to a plurality of icons, each being the icon, as the identification information for display, and displays the plurality of icons on the display.

5. The information terminal according to claim 1, further comprising:
an operation acceptor that accepts, from a user, an operation for specifying a placement position of the wireless communication device,
wherein the information processor displays the icon on the display having replaced the identification information for display with identification information corresponding to the placement position specified.

6. The information terminal according to claim 1,
wherein the information processor makes a notification of the identification information for display to the wireless communication device by communicating with the wireless communication device using the wireless communicator, and
the wireless communication device emits the beacon signal including the identification information for display after receiving the notification.

7. The information terminal according to claim 1,
wherein the information processor makes a notification of the identification information for display to the wireless communication device by communicating with the wireless communication device using the wireless communicator, and
the wireless communication device responds to an inquiry from the information terminal with the identification information for display after receiving the notification.

8. The information terminal according to claim 1,
wherein the wireless communication device is a lighting fixture including wireless communication functionality.

9. A communication system comprising:
the information terminal according to claim 1; and
the wireless communication device.

10. A display method executed by an information terminal including a display and storage, the display method comprising:
receiving a beacon signal emitted by a wireless communication device; and
when the beacon signal is received, (a) generating identification information for display, (b) displaying, on the display, an icon to which is assigned the identification information for display generated, the icon indicating the wireless communication device, and (c) storing, in the storage, a correspondence relationship between the identification information for display generated and unique identification information of the wireless communication device included in the beacon signal received.

11. A non-transitory computer-readable recording medium having recorded thereon a program for causing the information terminal to execute the display method according to claim 10.
